(19) United States
(12) Patent Application Publication
(10) Pub. No.: US 2023/0229831 A1
(43) Pub. Date: Jul. 20, 2023

(54) STRUCTURE STATE DISPLAY SYSTEM

(71) Applicant: NEXT INNOVATION INC., Minato-ku, Tokyo (JP)

(72) Inventor: Hiroshi Michiwaki, Minato-ku, Tokyo (JP)

(21) Appl. No.: 17/905,750

(22) PCT Filed: Mar. 2, 2021
(86) PCT No.: PCT/JP2021/008024

§ 371 Date: Apr. 7, 2023

(30) Foreign Application Priority Data
Mar. 5, 2020 (JP) 2020-038281

(51) Int. Cl. G06F 30/23; G01P 15/18; G01M 5/00; G06F 30/13

(52) U.S. Cl. CPC G06F 30/23; G01P 15/18; G01M 5/0041; G06F 30/13; G06F 2119/14

(57) ABSTRACT

A structure state display system has a measurement means, disposed in a structure, for measuring a physical state relating to the structure, an acquisition means for acquiring measurement information measured with the measurement means, and a creation means for applying a virtual physical quantity according to the measurement information to a design model including the structure and creating a virtual model in which a display showing the physical state of the structure in the design model is changed, and the virtual model is displayed on display means.

### CROSS-REFERENCE TO RELATED APPLICATIONS

This application is a national phase entry under 35 U.S.C. § 371 of International Patent Application PCT/JP2021/008024, filed Mar. 2, 2021, designating the United States of America and published as International Patent Publication WO 2021/177325 A1 on Sep. 10, 2021, which claims the benefit under Article 8 of the Patent Cooperation Treaty to Japanese Patent Application Serial No. 2020-038281, filed Mar. 5, 2020.

### TECHNICAL FIELD

The present disclosure relates to a structure state display system.

### BACKGROUND

Conventionally, a displacement recording system of a base-isolated building that calculates the strain amount of a base isolation device or an external force applied to the building due to an earthquake is known (for example, refer to Patent Literature 1), accelerations in a three-dimensional direction that are applied to the base isolation device due to the shaking of the ground upon the occurrence of the earthquake are detected with a base isolation device-side acceleration detector, and an acceleration due to the shaking of the building attributed to the resonance with a long-period earthquake ground motion is detected with a building-side acceleration detector. In addition, the strain amount of the base isolation device or the deformation amount of the building is calculated by performing a predetermined computation on the detected accelerations, and the strain amount and the deformation amount are displayed on display means.

In addition, an inspection method of a concrete building by which the inside quality of the concrete structure is perceived by reading information from a sensor in a state where the sensor has been inserted into an inspection hole on the wall surface of the concrete structure is known (for example, refer to Patent Literature 2).

### CITATION LIST

### Patent Literature

[Patent Literature 1] Japanese Unexamined Patent Publication No. 2020-12723
[Patent Literature 2] Japanese Unexamined Patent Publication No. 2018-13404

### BRIEF SUMMARY

The above-described displacement recording system described in Patent Literature 1 is a system capable of monitoring the strain amount of the base isolation device and the deformation amount of the building in real time when an earthquake has occurred by displaying the strain amount of the base isolation device computed with base isolation device displacement amount calculation means and the deformation amount of the building computed with building displacement amount calculation means, but there is a problem in that, while inspectors accustomed to monitoring are able to perceive the status of the building from the simple display of the strain amount and the deformation amount, it is impossible or extremely difficult for other people to perceive the status of the building.

In addition, the inspection method of a concrete building of Patent Literature 2 has a problem in that, even when a plurality of sensors is provided such that the overall status of a concrete building can be perceived, it is extremely difficult for people other than inspectors to perceive the status of the building based on information obtained from each sensor.

The present disclosure has been made by intensive studies in consideration of the above-described problems, and an objective of the present disclosure is to provide means for displaying a screen from which the status of a structure can be intuitively perceived.

A structure state display system of the present disclosure has a measurement means, disposed in a structure, for measuring a physical state relating to the structure, an acquisition means for acquiring measurement information measured by the measurement means and a creation means for applying a virtual physical quantity according to the measurement information to a design model including the structure and creating a virtual model in which a display showing the physical state of the structure in the design model is changed, and the virtual model is displayed on a display means.

In addition, in the structure state display system of the present disclosure, the physical quantity includes at least one of a stress, a load and an acceleration.

In addition, in the structure state display system of the present disclosure, the virtual model shows deformation of the structure in the design model, a change in a color of the structure in the design model and/or a change in numerical information of the structure in the design model.

In addition, in the structure state display system of the present disclosure, the measurement means performs a measurement every predetermined time and sends the measurement information, and the creation means creates the virtual model every predetermined time and displays a change in the physical state of the structure over an elapse of time with a plurality of the virtual models on the display means.

In addition, in the structure state display system of the present disclosure, the measurement information includes stress information.

In addition, in the structure state display system of the present disclosure, the measurement means includes a means for measuring accelerations in a plurality of directions and measures an orientation of a stress acting on a building, and a virtual model of the structure being deformed along the orientation of the stress is displayed on the display means.

In addition, the structure state display system of the present disclosure has storage means for linking the design model to information showing a location and storing the design model, and information showing the location linked to the design model that has been a base of the virtual model is displayed on the display means.

In addition, in the structure state display system of the present disclosure, the information showing the location includes coordinate information and/or map information.

In addition, the structure state display system of the present disclosure has determination means for determining a cause for making the stress act on the structure from the measurement information by the measurement means, and a determination result is displayed on the display means.

In addition, in the structure state display system of the present disclosure, the cause is a seismic load, a wind load, a live load, a collision load, a tsunami load, a wave load and/or a water current load.

### Advantageous Effects of Present Disclosure

According to the present disclosure, it is possible to display a screen from which the status of a structure can be intuitively perceived with a simple structure.

### BRIEF DESCRIPTION OF THE DRAWINGS

FIG. 1 is a view showing the overall configuration of a structure state display system of the present embodiment.

FIG. 2 is a perspective view showing a structure in a building in an enlarged manner.

FIG. 3 is a perspective view showing a structural example of a case where a screw member is adopted as a male screw body.

FIG. 4 is a perspective view showing a head of the screw member of the present embodiment.

FIG. 5 is a view showing a shaft of the screw member of the present embodiment.

FIG. 6 is a perspective view showing a head cap.

FIG. 7 is a block diagram showing the configuration of a substrate that is mounted on the head.

FIG. 8 is a block diagram showing a monitoring device of the present embodiment.

FIG. 9 is a view showing a virtual model image.

FIG. 10 is a view showing a virtual model image example.

FIG. 11 is a view showing an example of a map of a wide area.

FIG. 12 is a view showing an example of a map of a local region.

FIG. 13 is a view showing a display example of a mapping image.

FIG. 14 is a view showing a display example of a mapping image.

FIG. 15 is a view showing a display example of a mapping image.

FIG. 16 is a view showing a display example of a mapping image.

### DETAILED DESCRIPTION

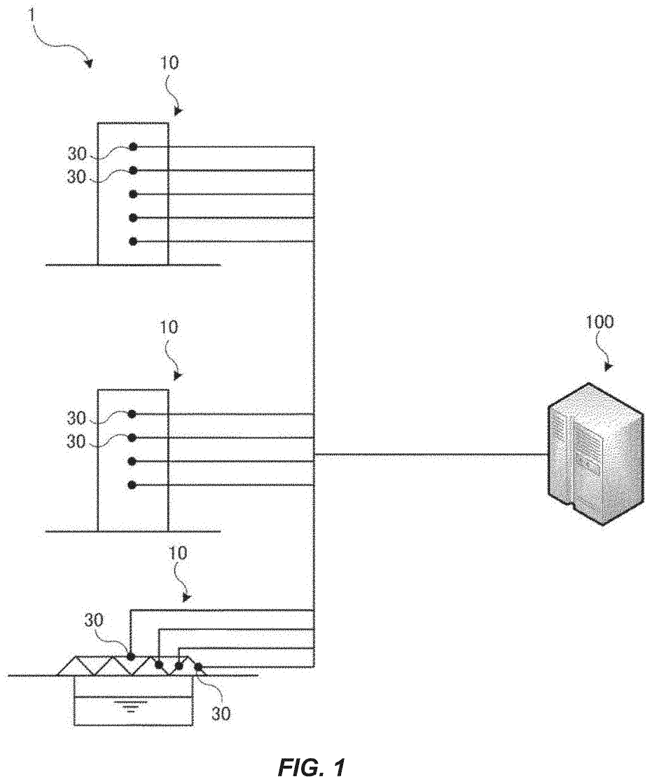

Hereinafter, a structure state display system of the present disclosure will be described with reference to drawings. FIG. 1 is a view showing the overall configuration of a structure state display system 1 of the present embodiment. Here, a case where a structure (a column, a beam or the like) in a building is displayed will be described as an example, but it is also possible to display a structure relating to a variety of buildings other than the above-described building such as a bridge, a road, a railroad rail, a traffic light, a utility pole, a steel tower, a wind power tower or wing, an airport terminal, a hospital, a government building, a tunnel, a dam, a water wheel, a floodgate and a sea-based facility, a variety of members that are used for the above-described buildings such as a building material or a structural material, industrial machinery such as construction machinery and a machine tool or other mechanical devices, consumables such as a fastening member, a gear, a blade and a holding member that configure the industrial machinery or other mechanical devices, element parts such as a spring, a bearing and a linear guide, a variety of transportation means such as a rocket, an aircraft, a submarine, a ship, a train, a bus, a truck, a passenger car, a motorcycle, a bicycle and an elevators and the like.

The structure state display system 1 is configured to include a plurality of buildings 10 such as buildings or bridges, screw members 30 that are used as members during the construction of these buildings 10 and a monitoring device 100 that is connected to these screw members 30 by wire or wirelessly.

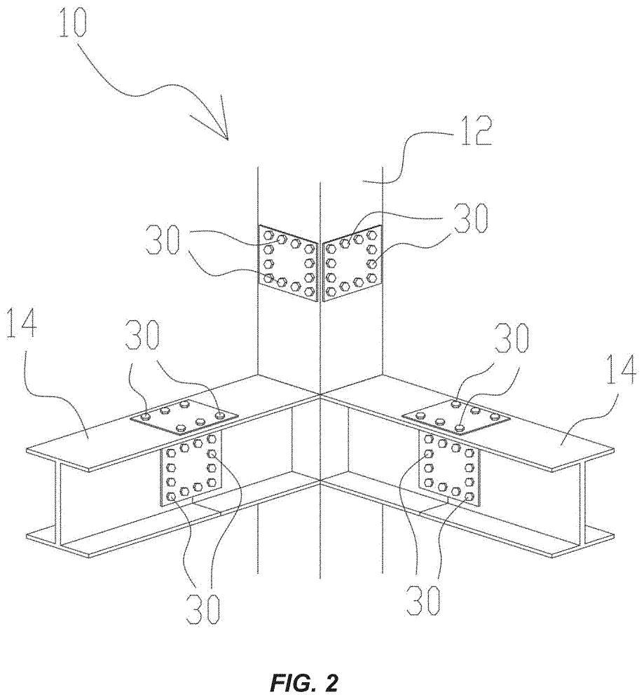

The screw member 30 is a male screw body, a female screw body, a washer or the like and preferably used as a basic structural member (structure) of the building 10. Specifically, as shown in FIG. 2, the screw members 30 are adopted in a variety of sites such as junctions where pillars 12 that are prismatic steel beams extending in the vertical direction of the building 10 are joined or junctions where beams 14 that are H steel beams extending in the horizontal direction from these pillars 12 are joined. That is, a place where the screw member 30 is used mainly becomes a portion where structures (frame materials) of the building 10 are joined. As described above, the screw members 30 are involved in the joining of structures and thereby may receive internal stresses that are generated in the structures indirectly.

Particularly, as shown in FIG. 2, in the plurality of screw members 30, places where the shaft directions of the screw members (fastening directions) differ from each other are preferably selected. In such a case, it is possible to use the screw members 30 as measurement means capable of three-dimensionally measuring the states of stresses that act on structures of the building 10 in the front and back direction, in the up and down direction and in the right and left direction.

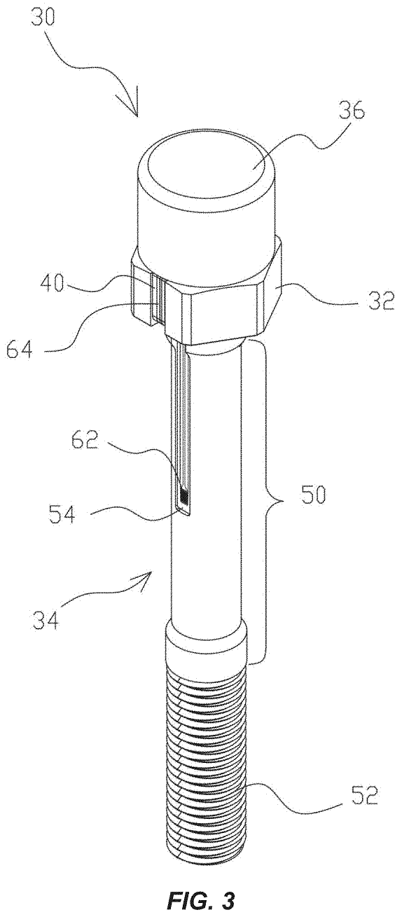

FIG. 3 shows a structural example of a case where the screw member 30 is adopted as a male screw body. The screw member 30 is a so-called bolt and has a head 32 and a shaft 34. In addition, in the screw member 30, a head cap 36, which is a separate body, is installed (fitted) on the head 32.

A substrate for detecting stresses such as a bending stress, a compressive stress, a tensile stress and a torsional stress is mounted in the head 32. Specifically, the substrate is disposed in the head 32, and the head cap 36 is installed to mount the substrate. The disposition position of the substrate is not necessarily limited to the head 32 and may be, for example, the tip portion of the shaft 34.

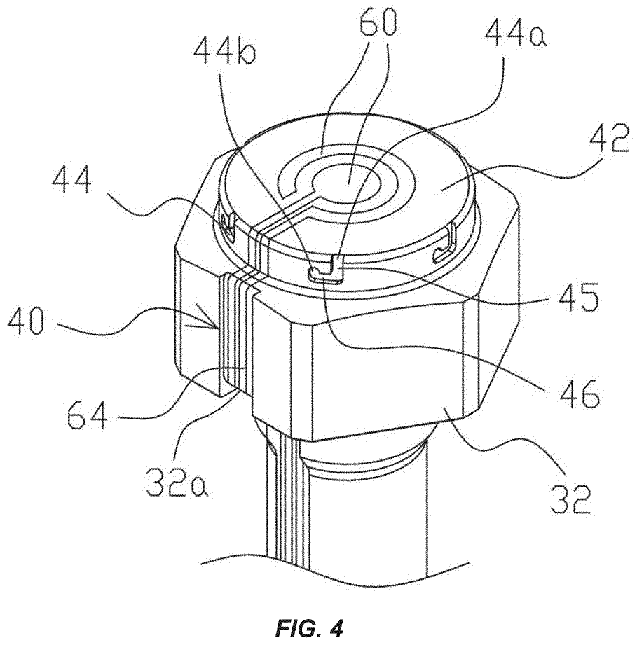

FIG. 4 is a perspective view showing the head 32 of the screw member 30 of the present embodiment. The head 32 has a hexagonal outer circumferential shape and includes three widths across flats. In addition, the head 32 has an external shape in which the maximum dimension in the shaft orthogonal direction, which is orthogonal to the shaft center, is large compared with that in the shaft 34, that is, the length (width) in the shaft orthogonal direction is large compared with that in the shaft 34. The head 32 has a recessed current path-disposed portion 40 that is continuous across one surface of the outer circumferential surface and the bearing surface. In addition, the head has a fitting portion 42 into which the head cap 36 can be fitted.

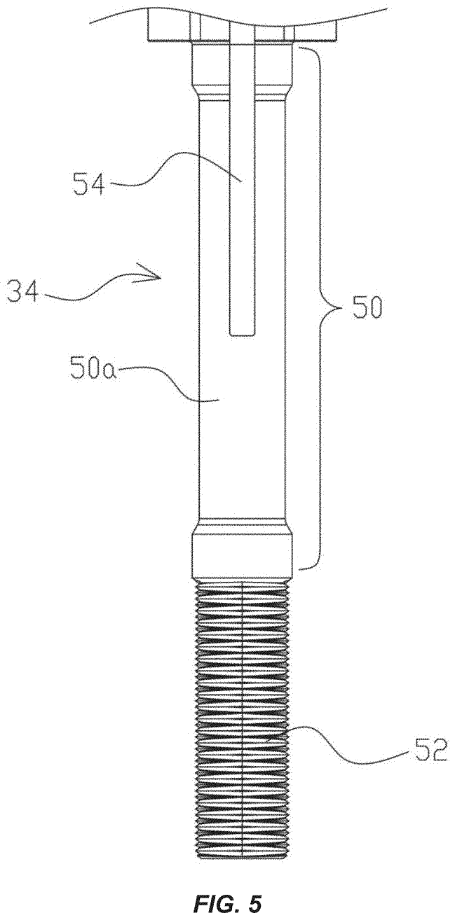

FIG. 5 is a view showing the shaft 34 of the screw member 30 of the present embodiment. In FIG. 5, a sensor pattern 132, which will be described below, is not shown. The shaft 34 has an external shape in which the length in the shaft direction is long compared with the maximum dimension in the shaft orthogonal direction. The shaft 34 includes a cylindrical portion 50 disposed on the base or bearing surface side of the head 32 and a screw portion 52 having a male screw spiral groove formed on the outer circumferential surface. That is, in the shaft 34, the cylindrical portion 50 is positioned on one end side where the head 32 is present, and the screw portion 52 is positioned on the other end side.

The cylindrical portion 50 has a columnar outer circumferential shape and has a contracted portion 50a with a contracted external form such that a partial region has a constriction with respect to all. This contracted portion 50a has a length in the shaft orthogonal direction set to be approximately the valley diameter or effective diameter of the male screw of the screw portion 52 and is set to be approximately the same as the effective diameter of the male screw in the present embodiment. The cylindrical portion 50 has a sensor-disposed portion 54 provided to be recessed with respect to the outer circumferential surface. The sensor-disposed portion 54 has a bottom surface portion forming a planar shape and is provided to extend toward the head 32 from the middle portion of the contracted portion 50a along the shaft direction.

The screw portion 52 has a first male screw spiral structure having spiral grooves formed at a predetermined lead angle and/or in a predetermined lead direction and a second male screw spiral structure having spiral grooves set at a lead angle and/or in a lead direction that are different from the lead angle and/or the lead direction of the first male screw spiral structure in a superimposed manner.

Here, two kinds of male screw spiral structures of the first male screw spiral structure that becomes a right-hand thread configured to enable the screwing of a female screw-like spiral thread formed as a corresponding right-hand thread and the second male screw spiral structure that becomes a left-hand thread configured to enable the screwing of a female screw-like spiral thread formed as a corresponding left-hand thread are formed to overlap each other on the same region in the shaft direction of the screw member 30. Surely, the first male screw spiral structure and the second male screw spiral structure may be produced as spiral structures in which the lead directions of the right-hand threads are the same as each other but the lead angles may be set to be different from each other. The spiral grooves do not necessarily need to be formed in a superimposed manner, but preferably have a mechanism capable of suppressing a backlash as a joining member from the viewpoint of performing precise and highly accurate strain measurement and stress measurement.

Therefore, the screw portion 52 can be screwed with any of a male screw body with a right-hand thread and a male screw body with a left-hand thread. Regarding the details of the screw portion 52 on which two kinds of male screw spiral grooves are formed, it is advised to refer to Japanese Patent No. 4663813 according to the present disclosure.

A sensor pattern 62 for detecting stresses that are generated in the shaft 34 is directly formed on the bottom surface of the sensor-disposed portion 54. That is, the sensor pattern 62 is capable of functioning as a strain measurement sensor for measuring strains that are generated in the screw member 30. In addition, the sensor pattern 62 is composed of a sensor structure portion that is made of a conductive material and extends in the shaft direction while reciprocating a plurality of times and a lead portion that extends from the sensor structure portion toward the head 32. Therefore, in the sensor pattern 62, an electrical characteristic such as the resistance value changes along with the deformation of the conductive material in the sensor structure portion. The sensor pattern 62 can be used as a strain sensor that detects a physical change of the shaft 34 by detecting a change in this electrical characteristic.

The physical change that is detected due to a change in the electrical characteristic may be a heat/temperature change, a humidity change or the like. For example, in a case where the ambient temperature is measured (that is, temperature data is calculated) from a change in the electrical resistance value of the sensor pattern 62, it means that the sensor pattern 62 is used as a configuration component of a so-called resistance thermometer. In addition, the sensor pattern 62 may measure the humidity (that is, may calculate humidity data) as a resistance change-type electrical humidity sensor in the same manner. Such a sensor pattern 62 is connected to a current path 64 formed on the head 32 so as to enable currents to flow.

Next, the current path-disposed portion 40 and the fitting portion 42 of the head 32 will be described. The current path-disposed portion 40 shown in FIG. 3 has a planar shape in the bottom surface portion of the recessed cross section, and the current path 64 is directly formed on the bottom surface portion. The extension direction of the current path-disposed portion 40 is set such that the current path-disposed portion extends along the shaft direction on the outer circumferential surface of the head 32 and extends in a direction orthogonal to the shaft direction on the bearing surface. As long as the current path-disposed portion 40 is continuous across at least the outer circumferential surface and bearing surface of the head 32, the extension direction can be set as appropriate such that the current path-disposed portion extends in a direction inclined with respect to the shaft direction on the outer circumferential surface. In addition, the depth, width or the like of the current path-disposed portion 40 can also be set as appropriate.

The fitting portion 42 has a cylindrical shape protruding in the shaft direction from the end surface (end portion) of the head 32. In addition, the fitting portion 42 has a plurality of locking grooves (locking portions) 44 on the outer circumferential surface shown in FIG. 4. Furthermore, a terminal 60 electrically connected to the current path 64 is directly formed on the end surface of the fitting portion 42.

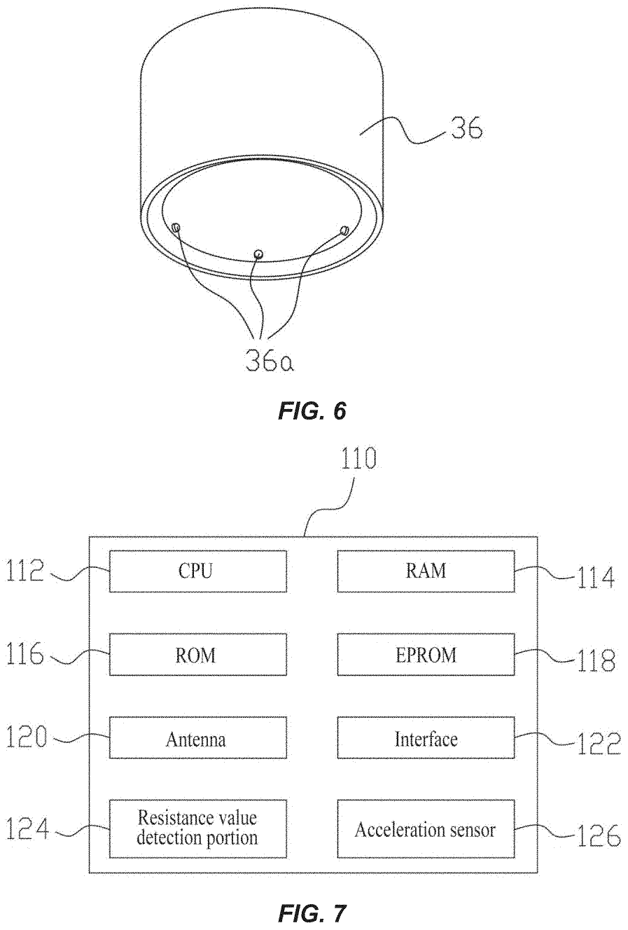

The locking grooves 44 formed on the outer circumferential surface of the fitting portion 42 form a shape that enables the insertion of locking pieces 36a (refer to FIG. 6) of the head cap 36 and the confinement of the positions in the shaft direction of the head cap 36, for example, a substantially L shape.

In this case, the locking groove 44 is formed to include a shaft direction guide portion 45 and a circumferential direction guide portion 46. The shaft direction guide portion 45 is provided to extend along the shaft center from an insertion opening 44a and guides the movement of the locking piece 36a in the shaft direction. The circumferential direction guide portion 46 curves or bends along the circumferential direction with respect to the shaft direction guide portion 45 and forms a confining end portion 44b on the terminal side. The confining end portion 44b is a portion bent so as to extend toward the top surface of the head 32 along the shaft direction. The locking piece 36a fits to the confining end portion 44b, which makes it possible to confine the movement of the locking piece 36a in the shaft direction and in the circumferential direction.

FIG. 6 is a perspective view showing the head cap 36. The head cap 36 is a member that is installed to cover the fitting portion 42 of the head 32 and includes a plurality of the locking pieces 36a having a protrusion shape on the inner circumferential surface. An interposition member is desirably interposed between the head 32 and the head cap 36. Here, the interposition member is a so-called sealing member, packing or the like and formed of a flexible material, for example, an elastic body such as rubber or silicone. Surely, a flexible member mentioned herein is not limited to resin materials, and the flexible member is not particularly limited as long as a strong fitting state can be obtained by elastically and/or plastically deforming the flexible member.

Next, an example of forming the terminal 60, the sensor pattern 62 and the current path 64 will be described. First, the terminal 60, the sensor pattern 62 and the current path 64 are directly formed on the surface of the screw member 30. For example, in a case where the base material of the screw member 30 is conductive, an electrical insulating layer is formed on the surface of the screw member 30, and a conductive portion that forms the patterns of the terminal 60, the sensor pattern 62 and the current path 64 is formed of a material having a favorable electrical conductivity, such as a conductive material, on the electrical insulating layer.

The electrical insulating layer can be formed using, for example, laminated printing, pad printing, painting, plating, inkjet printing, sputtering, a chemical vapor deposition method (CVD method), a physical vapor deposition method (PVD method) or the like. Alternatively, a method in which an insulating material is sputtered in a state where a predetermined mask is disposed to form a coating, a method in which a silica material is applied and a heating treatment is performed, a method in which a layer is formed of an organic insulating material such as a polyimide-based material, an epoxy-based material, a urethane-based material, a silicone-based material or a fluorine-based material or the like may be used.

In a case where the base material of the screw member 30, that is, the head 32 or the shaft 34 is electrically conductive, an oxide film may be formed by performing an oxidation treatment on the surface of the base material and used as the electrical insulating layer. In addition, in a case where the base material is an aluminum-based material, the electrical insulating layer may be provided by an alumite treatment. Surely, the electrical insulating layer is not limited to layers that are formed by these methods. In addition, in a case where the base material of the screw member 30 is electrically conductive, a conductive portion that forms the patterns of the terminal 60, the sensor pattern 62 and the current path 64 may be formed on the base material without forming the electrical insulating layer.

The conductive portion is directly formed on the electric insulating layer by lamination printing, pad printing, painting, plating, ink jet printing, sputtering, the CVD method, the PVD method or the like in which a conductive paste is used. In addition, on the conductive portion, the shape of a wire may be set by providing a mask adapted to the shapes of the terminal 60, the sensor pattern 62 and the current path 64 and performing etching. When the conductive portion is directly formed on the electrical insulating layer, peeling of the conductive portion is prevented for a long period of time.

Surely, the terminal 60, the sensor pattern 62 and the current path 64 may be continuously formed on the screw member 30. In that case, it is preferable to perform a process such as round chamfering on a boundary portion 32a between a parallel surface parallel to the shaft present in the shaft direction of the screw member 30 and an orthogonal surface approximately orthogonal to the parallel surface to form a curved shape. In such a case, the conductive portion can be formed more easily than in a case where the conductive portion is formed on a surface on which the portion between the parallel surface and the orthogonal surface becomes angular.

FIG. 7 is a block diagram showing the configuration of a substrate 110 that is mounted in the head 32. The substrate 110 has a CPU 112 that is composed of an analog circuit and/or an IC chip or the like and acts as a central processing unit that controls all processing, a high-speed memory RAM 114 for reading and writing temporary data, a read-only memory ROM 116 that is used to store programs, a memory EPROM 118 that is writable to store data, an interface 120 that controls communication between the substrate and the outside, an antenna 122 that communicates with the outside wirelessly or supplies power using external radio waves, a resistance value detection portion 124 and an acceleration sensor 126.

In addition, power supply means for supplying power to each portion of the substrate 110 is disposed in the head 32. The power supply means can be a power supply circuit or the like connected to a built-in battery or an external power supply.

The resistance value detection portion 124 is electrically connected to the sensor pattern 62, which will be described below, and thereby detects a change in the resistance value (electrical characteristic) of the sensor pattern 62 attributed to deformation of the shaft 34 and, simultaneously, converts this value to digital information and supplies the digital information to the CPU 112. As a result, resistance value data is stored in the EPROM 118.

The acceleration sensor 126 detects accelerations in a three-dimensional direction and thereby discovers the vibrations or movements of the screw member 30 and calculates the acceleration data of the screw member 30, which contains vibration orientations or movement orientations. This makes it possible to perceive motions of the bending or shaking of structures in the building 10. Acceleration data is stored in the EPROM 118.

The resistance value data or acceleration data that is stored in the EPROM 118 is sent to the outside through the antenna 122 at any timing when the monitoring device 100 collects information or regular timing.

In the ROM 116 or the EPROM 118, information for identifying each screw member 30 (individual identification information) is stored, and, in the monitoring device 100, the addresses and names of the buildings 10, the installation places of structures and the like are registered in association with the individual identification information. Therefore, each screw member 30 is separately managed. In a part of the substrate 110, a so-called RFID technique for which an IC chip is used is adopted, but the present disclosure is not limited thereto, and other techniques may also be used.

The use of the EPROM 118 as a writable memory for storing data has been described; however, surely, it is needless to say that the writable memory may be a PROM.

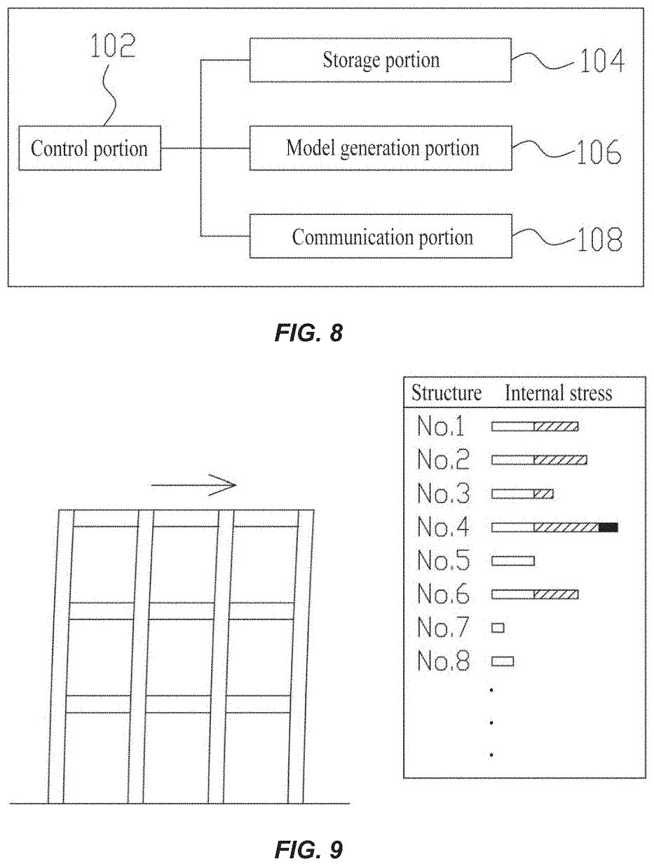

FIG. 8 is a block diagram showing the monitoring device 100 of the present embodiment. The monitoring device 100 is a so-called server and includes a control portion 102 that comprehensively controls individual portions. To the control portion 102, a storage portion 104, a model generation portion 106 and a communication portion 108 are connected.

The storage portion 104 stores control processing by the control portion 102, information and programs that are used for processing and the like. The storage portion 104 can be a semiconductor memory, a magnetic memory, an optical memory or the like and is capable of functioning as a main storage device or an auxiliary storage device. In addition, the storage portion 104 may be a cache memory or the like that is included in the control portion 102. In addition, the storage portion 104 may be a volatile storage device or may be a non-volatile storage device.

In addition, the storage portion 104 stores map information. In addition, the storage portion 104 includes a table where the names and position information (the addresses or the like of the buildings 10) of the buildings 10 in which the screw members 30 are used, the installation places of the structures or the screw members 30, installation directions (orientations), installation postures and the like are stored in association with the individual identification information of the screw members 30 and, additionally, the resistance value data, acceleration data and the like collected from the individual screw members 30 are accumulated chronologically. For example, the table can be set for each design model (which will be described below).

In addition, the storage portion 104 stores design models created according to the intrinsic designs of the buildings 10 composed of a plurality of structures. For example, the design model is a blueprint (CAD data) or the like of the building 10 and contains the information of the screw members 30 or structures that are actually in use.

The model generation portion 106 creates virtual models using the design models stored in the storage portion 104 and the information accumulated in the table. That is, the resistance data and the acceleration data for each screw member 30, furthermore, in addition to these, temperature data and the like are analyzed, and how the structure is deformed is analyzed based on data analyzed from a plurality of the screw members 30. In addition, virtual models that virtually reproduce the shape of the entire building 10 based on the deformation of each structure are created.

The communication portion 108 performs communication processing with the screw members 30 or an external terminal through an antenna, not shown. The communication processing by the communication portion 108 are not limited to wireless treatments, and it is needless to say that the treatments may be performed by wire. In addition, the antenna is not limited to a case where the antenna is disposed in the monitoring device 100 and may be a relay antenna disposed near the screw member 30 in each building 10.

The external terminal is preferably an information processing terminal capable of displaying virtual model images and capable of communicating with the monitoring device 100, and the kind thereof is not limited. That is, the external terminal has, for example, a smartphone, a mobile phone (feature phone), a personal digital assistant (PDA), a wearable terminal (a head-mounted display, a glasses-type device or the like), a tablet terminal, a notebook PC, a desktop PC, a variety of other computers or arithmetic circuits, a monitor or the like.

In addition, the communication between the monitoring device 100 and the external terminal may be established through a network and may be through, for example, a wireless network or a wire network, and specific examples of the network include a wireless LAN, a wide area network (WAN), an integrated service digital networks (ISDNs), a long term evolution (LTE), LTE-advanced, a code division multiple access (CDMA), a fifth generation mobile communication system (5G), a low power wide area (LPWA) and the like. Surely, the network may be a network in which Wi-Fi, a public switched telephone network, Bluetooth, an optical line, an asymmetric digital subscriber line (ADSL), a satellite communication network, an AM wave, an FM wave or the like is used or may be a network that is a combination thereof.

According to such a structure state display system 1, it is possible to a display virtual model image based on the virtual model generated by the monitoring device 100 on the external terminal. Specifically, the monitoring device 100 performs a processing of collecting the resistance value data and the acceleration data from the screw members 30, furthermore, in addition to these, temperature data and the like, a processing of creating a virtual model and a processing of displaying a virtual model image on the external terminal.

First, in the screw member 30, the CPU 112 acquires resistance value data with the resistance value detection portion 124 and acceleration data with the acceleration sensor 126. The CPU 112 stores the resistance value data and the acceleration data in association with the individual identification information in the EPROM 118. In addition, the CPU 112 sends the resistance value data and the acceleration data associated with the individual identification information to the monitoring device 100.

The control portion 102 in the monitoring device 100 receives the resistance value data and the acceleration data associated with the individual identification information from the screw member 30 and generates a virtual model with the model generation portion 106. At this time, the control portion 102 refers to the storage portion 104, specifies the building 10 based on the received individual identification information and retrieves the design model of the building 10.

The control portion 102 performs a virtual model generation processing with the model generation portion 106. The model generation portion 106 specifies an internal stress generated in the structure from the resistance value data of each screw member 30 and specifies the deformation orientation, deformation amount or the like of each structure from the acceleration data of each screw member 30. In addition, the internal stress specified for each structure in the design model is applied as a virtual stress, and a virtual model composed of structures deformed by the virtual stresses is created. At this time, the virtual stresses that are applied to the structures are caused to act along an orientation based on the acceleration data specified above.

The control portion 102 sends the virtual model to the external terminal with the communication portion 108, whereby a virtual model image is displayed on the display screen of the external terminal.

Here, FIG. 9 is a view showing the virtual model image, and, for example, on the virtual model image of a virtual model generated from resistance value data and acceleration data acquired upon an earthquake, structures in the building 10 that has been inclined due to earthquake motions, an internal stress generated in each structure and the like are displayed.

The internal stresses that are displayed on the virtual model image are indicated by horizontal bar charts, and, furthermore, the ranges of the internal stresses beyond a specific value are displayed in color. In addition, in the virtual model image, numerical value information indicating the internal stresses may also be displayed. The numerical value information indicating the internal stresses may be displayed in place of the horizontal bar charts or may be displayed together with the horizontal bar charts. Surely, here, a variety of information is indicated by the horizontal bar charts in order to facilitate the intuitive perception of the states of the structures, but it is needless to say that how to display the information is not limited thereto.

According to the above-described structure state display system 1, a plurality of the screw members is used in structures of the building 10, whereby it becomes possible to discover strains and/or displacement generated in the screw members. These discovery results are collected by the monitoring device and thus can be utilized as objective data.

In addition, the virtual model image is displayed on the display screen of the external terminal, whereby it is possible even for users not accustomed to recognizing the state of a building from deformation or internal stresses that are generated in a structure to intuitively recognize the states of the structure and the building, and the recognized states can be utilized to determine a risk or the like attributed to the collapse or destruction of the building.

The CPU 112 mounted in the screw member may acquire and send the resistance value data and the acceleration data substantially at the same time, but may send the resistance value data and the acceleration data at predetermined intervals, and, in such a case, the resistance value data and the acceleration data that are accumulated in the EPROM 118 may be retrieved chronically and sent to the monitoring device 100.

In addition, the resistance value may be measured at all times, but may also be measured every certain interval and the acceleration is measured at all times and the resistance value data may be acquired when the acceleration data has deviated from a predetermined range. In addition, at a timing when the acceleration data has deviated from a predetermined range, the resistance value data and the acceleration data may be sent at the same time.

Surely, the resistance value data and the acceleration data may be acquired and sent at all times, but the resistance value data and the acceleration data may be acquired and sent upon demands from the monitoring device 100.

In addition, measurement data such as the resistance data, the acceleration data and the temperature data may be sent to the monitoring device 100 upon a user's commands. That is, when a user input a command of demanding measurement data such as the resistance data, the acceleration data and the temperature data through input means (for example, a keyboard or the like) of the monitoring device 100 or through the monitoring device 100 from a user terminal, the monitoring device 100 may receive the measurement data such as the resistance data, the acceleration data and the temperature data from the screw members 30.

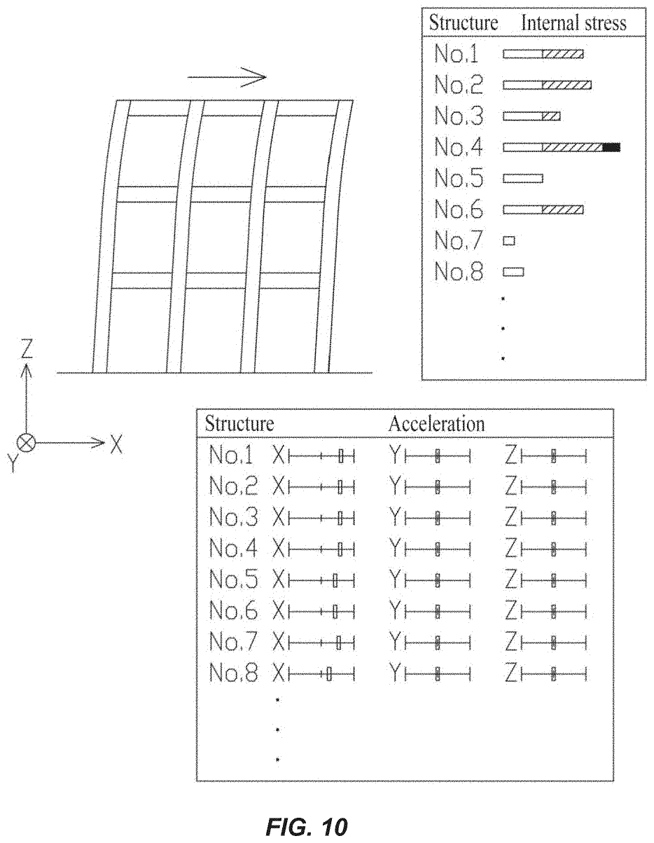

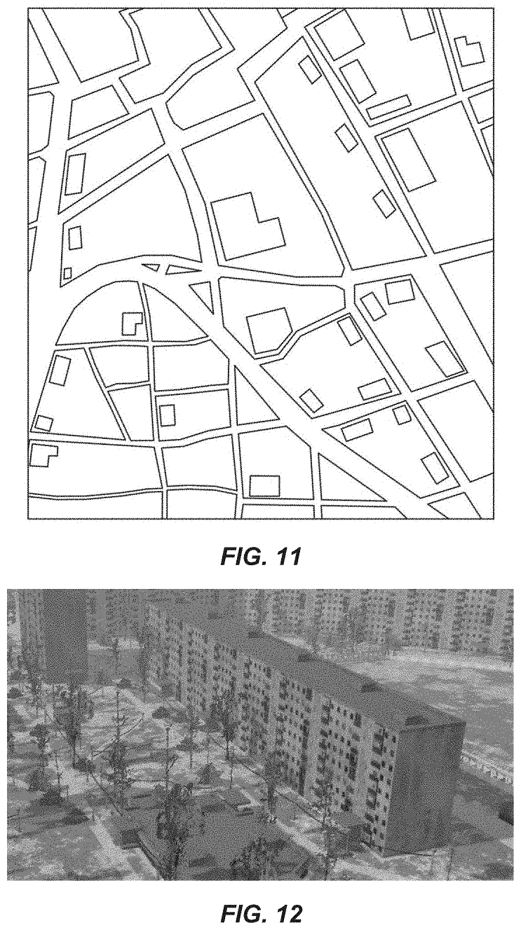

In addition, the virtual model image may contain synthetic acceleration information based on the acceleration data. Accelerations in this case may be configured so as to be indicated by orientations along the X axis, the Y axis and the Z axis in the orthogonal coordinate system of a three-dimensional space. For example, it is possible to display a slider-like gauge and a marker that alters in position on this gauge for each of the X axis, the Y axis and the Z axis as shown in FIG. 10 and show an acceleration along each axis by the movement and/or position of the marker. Surely, numerical value information indicating accelerations may also be displayed together.

In addition, a structure that has been deformed in the virtual model image may be shown as being deformed larger than the actual deformation amount, for example, by a shape as shown in FIG. 10. This is, some structures have high rigidity and thus they are rarely deformed in spite of large internal stresses in some cases. Regarding such structures, even when the actual deformation amount is indicated, there are cases where it is difficult to perceive the state, and thus, when the deformation amount is amplified and displayed, it is possible to obtain an effect of facilitating more intuitive perception of the states of the structures.

In addition, if the monitoring device collects the resistance data, the acceleration data, the temperature data and the like and generates virtual models at all times, it becomes possible to observe the appearance of a building substantially in real time, which makes it possible to perceive the appearance of the deformation of the building, the state or change of internal stresses and the like when an earthquake or the like has occurred. Based on this status, it is also possible to determine maintenance priority or important sites.

In addition, the monitoring device 100 may be further provided with a determination portion that determines the kind of a load that causes internal stresses to act. In a case where the determination portion is provided, the kind of the load may be displayed on the virtual model image by adding the kind of the load to the virtual model. Here, examples of the kind of the load include a seismic load, a wind load, a live load (a car load or a train load), a collision load, a tsunami load, a wave load, a water current load and the like.

In addition, in the above-described embodiment, the virtual model has been created by applying the internal stresses (physical quantity) of the structure based on the resistance value data of the screw members to the design model, but accelerations based on the acceleration data of the screw members may also be applied to the design model as the physical quantity, and the virtual model may be created by specifying loads on the structure based on the resistance value data of the screw members and applying the loads to the design model as the physical quantity.

The determination portion is capable of specifying whether a load has been suddenly generated or routinely generated by monitoring resistance value data and acceleration data chronologically, specifying where in the building 10 the internal stress has become large and determining the kind of a load with the orientation or magnitude of the load, the ways of changes of the orientation and magnitude or the like. Surely, the determination method of the kind of the load is not limited to the above-described method and can be set as appropriate.

The virtual model may be a model containing the external surface information of the building 10. That is, the virtual model may be a model capable of displaying the appearance of the building 10. In that case, the storage portion 104 stores the external surface information of the building 10 containing the shape information of the external surface of the building 10, surface material information or the like in advance. In addition, the model generation portion 106 is made to be capable of generating virtual model in which the external surface information has been reflected in the design model. Therefore, on virtual model images based on the virtual model, the external surface can be displayed to superimpose the structures of the building 10.

However, when the virtual model image containing the external surface information has been displayed, there is a concern that, conversely, it may become difficult to see a site in the structure where an internal stress has been generated due to the external surface. Therefore, the structure state display system may be configured to be capable of switching the display of the external surface and the display of the structure excluding the external surface. Surely, it is needless to say that only the external surface information may be displayed without being displayed to superimpose the structures.

In addition, the model generation portion 106 may generate a mapping image, in which the building 10 is disposed at an appropriate position on a map, by storing 2D or 3D map model in the storage portion 104 in advance. That is, the model generation portion 106 may generate the mapping image by combining the map model and the virtual model.

Here, the map model is data for displaying a map image in a virtual coordinate system corresponding to orientations on the actual earth. In addition, the mapping image displays the building 10 by the virtual model image in an orientation matching the actual installation orientation in the map image. In addition, the mapping image may display the map and/or the building 10 two-dimensionally or three-dimensionally as desired. For example, while a map of a broad region is displayed two-dimensionally as shown in FIG. 11, a map of a local region is displayed three-dimensionally as shown in FIG. 12. In such a case, it is possible to reduce the processing load in the monitoring device 100 and the external terminal and to enable nimble operation displays.

In addition, the mapping image may display a plurality of the buildings 10. That is, the mapping image may be created by associating the virtual model of each building 10 with the map model. In addition, the mapping image may be created to enable a change in the magnification of the region of a display target and to enable the region of the display target to be moved to an arbitrary position on the map.

In addition, on a 3D map image, a 3D map in a three-dimensional coordinate system corresponding to orientations on the map (a three-dimensional map made to be three-dimensional by adding information of altitudes or the height of the building 10 or the like in the vertical direction to the information of a plane) is displayed, and a three-dimensional image of the building 10 made to be three-dimensional is displayed to superimpose the 3D map. At this time, the 3D map image may be created to enable the building 10 to be displayed in an arbitrary direction or angle. Specifically, the 3D map image may be created to enable the building 10 to be displayed at an arbitrary altitude and the horizontal angle, to be displayed at an angle so as to be looked down from above or to be displayed at an angle so as to be looked up from the ground.

In addition, the 3D map image is created to enable the building 10 to be displayed in an enlarged or reduced manner. According to this, it is possible to display an arbitrary site (for example, a site where a high internal stress has been generated or the like) in the building 10 in an enlarged manner or to display the building 10 in a reduced manner so as for the overall image of the building 10 to be displayed. The 3D map image may be created to display a 2D or 3D background image of the surroundings when the building 10 is displayed in an enlarged or reduced manner. That is, in a case where other buildings or the like are present in the surroundings, the other buildings may be displayed.

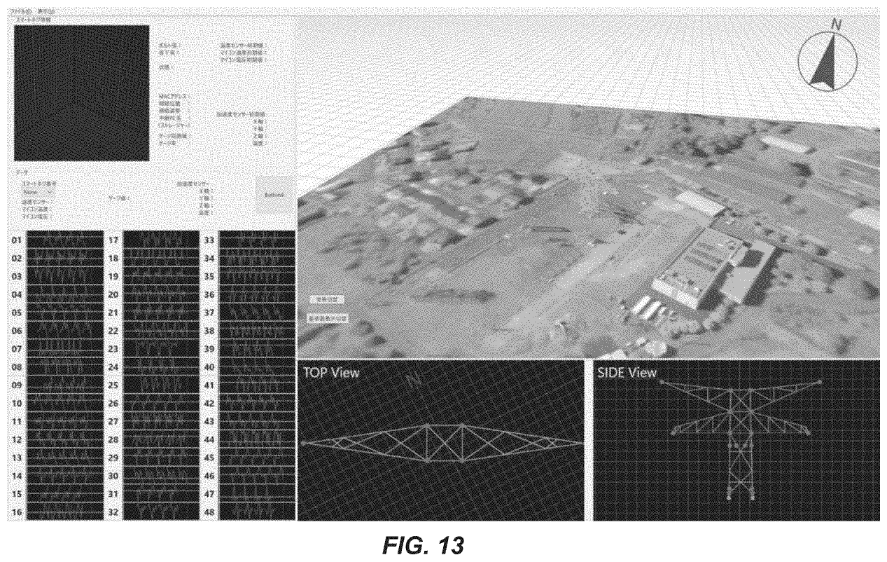

FIGS. 13-16 are views showing display examples of mapping images in a case where a plurality of the screw members 30 is disposed in a steel tower. On a screen of a mapping image that is displayed on the external terminal, a display region that is positioned on the right side of the screen shown in FIG. 13 and displays the steel tower as a building on a map, a screw member position display region in which the disposition sites of the screw members 30 are made to superimpose the top view or side view of the steel tower, also, a stress display region that is positioned on the left side of the screen and displays an internal stress that has been generated in each screw member 30 disposed in the steel tower, a designated member display region and the like are disposed.

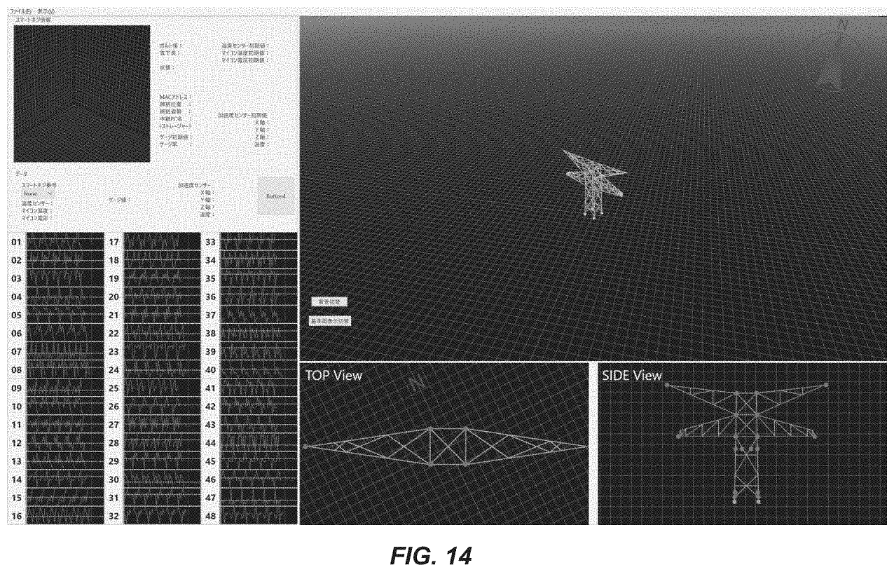

The display region displays not only an image on which the steel tower is made to superimpose the background image but also information that indicates orientations. The background image is displayed in the display region, but the display can be switched to an image on which only the steel tower excluding the background image is displayed as shown in FIG. 14.

In addition, in the screw portion position display region, the disposition positions of the screw members 30 are displayed by marking sites where the screw member 30 is disposed with circles or the like on the top view or side view of the steel tower. In addition, the member position display region displays the top view and side view of the steel tower, but the display can be switched to a side view or the like where the steel tower is seen from a different side so as to indicate the steel tower in a different arbitrary orientation.

In addition, the external terminal may receive an input operation such that a screw member 30 can be designated from the steel tower while the mapping image is being displayed. That is, when a screw member 30 that is in use in the steel tower, which is being displayed, has been designated, the designated screw member 30 may be displayed such that the installation orientation and installation posture of the screw member 30 can be viewed. At this time, the screw member 30 may be designated by inputting a designation into an input field for designating a screw member or an appropriate input method can be set so that the screw member may be designated by designating a mark in the screw member position display region.

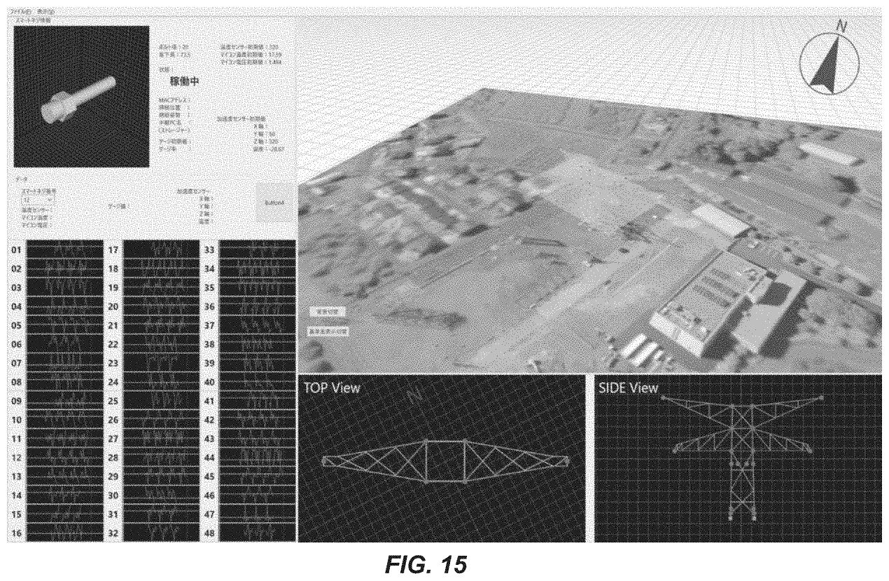

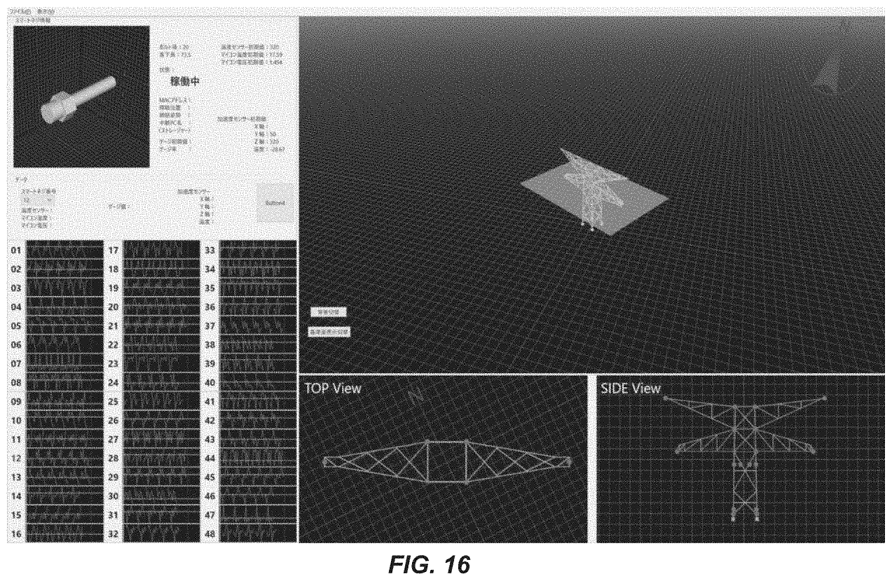

When a screw member 30 has been designated, the screw member 30 is displayed so as to display the actual installation orientation and installation posture in the designated member display region in an upper left portion of the screen as shown in FIG. 15. That is, the screw member 30 is displayed in the actual installation orientation in association with the orientation displayed in the display region. Therefore, it becomes possible to view in what installation orientation and what installation posture the designated screw member 30 is fixed with respect to the orientation of the steel tower that is being displayed in the mapping image. Surely, it is needless to say that, even while the designated screw member 30 is being displayed, the display can be switched to a screen that displays the steel tower excluding the background image as shown in FIG. 16.

### REFERENCE SIGNS LIST

1 Structure state display system, 10 building, 12 pillar, 14 beam, 30 screw member, 32 head, 34 shaft, 36 head cap, 40 current path-disposed portion, 42 fitting portion, 44 locking groove, 45 shaft direction guide portion, 46 circumferential direction guide portion, 50 cylinder portion, 50a contracted portion, 52 screw portion, 54 sensor-disposed portion, 60 terminal, 62 sensor pattern, 64 current path, 100 monitoring device, 110 substrate, 112 CPU, 114 RAM, 116 ROM, 118 EPROM, 120 interface, 122 antenna, 124 resistance value detection portion, 126 acceleration sensor.

1. A structure state display system comprising:
a measurement sensor, disposed in a structure, for measuring a physical state relating to the structure;
one or more processors configured to:
acquire measurement information measured by the measurement sensor; and apply virtual physical quantity according to the measurement information to a design model including the structure and creating a virtual model in which a display showing the physical state of the structure in the design model is changed,
wherein the virtual model is displayed on a display screen.

2. The structure state display system according to claim 1,
wherein the measurement sensor comprises a sensor pattern to detect resistance change for sensing at least one of a strain and a humidity, and
the physical quantity includes at least any one of a stress, a load and an acceleration.

3. The structure state display system according to claim 1,
wherein the virtual model shows deformation of the structure in the design model, a change in a color of the structure in the design model and/or a change in numerical information of the structure in the design model.

4. The structure state display system according to claim 1,
wherein the measurement sensor performs a measurement every predetermined time and sends the measurement information, and
the one or more processors is further configured to:
create the virtual model every predetermined time; and
display a change in the physical state of the structure over an elapse of time with a plurality of the virtual models on the display screen.

5. The structure state display system according to claim 1,
wherein the measurement information includes stress information.

6. The structure state display system according to claim 1,
wherein the measurement sensor includes an acceleration sensor for measuring accelerations in a plurality of directions and measures an orientation of a stress acting on a building, and
a virtual model of the structure being deformed along the orientation of the stress is displayed on the display screen.

7. The structure state display system according to claim 1, further comprising:
storage for linking the design model to information showing a location and storing the design model,
wherein information showing the location linked to the design model that has been a base of the virtual model is displayed on the display screen.

8. The structure state display system according to claim 7,
wherein the information showing the location includes coordinate information and/or map information.

9. The structure state display system according to claim 1, the one or more processor is further configured to determine a cause for making a stress act on the structure from the measurement information by the measurement sensor,
wherein a determination result is displayed on the display screen.

10. The structure state display system according to claim 9,
wherein the cause is a seismic load, a wind load, a live load, a collision load, a tsunami load, a wave load and/or a water current load.

11. The structure state display system according to claim 2,
wherein the virtual model shows deformation of the structure in the design model, a change in a color of the structure in the design model and/or a change in numerical information of the structure in the design model.

12. The structure state display system according to claim 11,
wherein the measurement sensor performs a measurement every predetermined time and sends the measurement information, and
the one or more processors is further configured to:
create the virtual model every predetermined time; and
display a change in the physical state of the structure over an elapse of time with a plurality of the virtual models on the display screen.

13. The structure state display system according to claim 12,
wherein the measurement information includes stress information.

14. The structure state display system according to claim 13,
wherein the measurement sensor includes an acceleration sensor for measuring accelerations in a plurality of directions and measures an orientation of a stress acting on a building, and
a virtual model of the structure being deformed along the orientation of the stress is displayed on the display screen.

15. The structure state display system according to claim 14, further comprising:
storage for linking the design model to information showing a location and storing the design model,
wherein information showing the location linked to the design model that has been a base of the virtual model is displayed on the display screen.

16. The structure state display system according to claim 15,
wherein the information showing the location includes coordinate information and/or map information.

17. The structure state display system according to claim 16, the one or more processor is further configured to
determine a cause for making a stress act on the structure from the measurement information by the measurement sensor,
wherein a determination result is displayed on the display screen.

18. The structure state display system according to claim 17,
wherein the cause is a seismic load, a wind load, a live load, a collision load, a tsunami load, a wave load and/or a water current load.
